(19) United States
(12) Patent Application Publication
(10) Pub. No.: US 2006/0278844 A1
(43) Pub. Date: Dec. 14, 2006

(54) WORKING FLUID FOR HEAT PIPE AND METHOD FOR MANUFACTURING THE SAME

(76) Inventor: Tsai-Shih Tung, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,614

(22) Filed: Apr. 12, 2006

(30) Foreign Application Priority Data
Jun. 8, 2005 (CN) 200510035222.8

(51) Int. Cl. C09K 5/04

(52) U.S. Cl. 252/67; 977/900

(57) ABSTRACT

A working fluid for a heat pipe includes a liquid solvent; a plurality of nano-particles dispersed in the liquid solvent; and a polymer stability agent configured for preventing the nano-particles from aggregating in the liquid solvent. A method for manufacturing the working fluid includes the steps of: providing a vessel containing a liquid solvent containing a polymer stability agent dispersed therein, the polymer stability agent being configured for preventing the created nano-particles from aggregating in the liquid solvent; arranging a target in the liquid solvent; and bombarding the target to create nano-particles, whereupon the nano-particles are dispersed into the polar solvent, thereby obtaining the working fluid.

### FIELD OF THE INVENTION

The present invention generally relates to thermal dissipating materials, and more particularly to a working fluid for a heat pipe. The present invention also provides a method for manufacturing the working fluid.

### DESCRIPTION OF RELATED ART

Electronic components such as semiconductor chips are becoming progressively smaller, while heat dissipation requirements are correspondingly increasing. In many contemporary applications, a heat pipe is one of most efficient systems for transmitting heat away from such components.

A typical heat pipe is a vessel that includes a pipe, a wick and an amount of liquid working fluid. The wick is a capillary structure, and is fixed on an inner wall of the pipe. The liquid working fluid is sealed in the pipe and soaks the wick. One end of the heat pipe is an evaporating section, and another end of the heat pipe is condensing section. The evaporating section is disposed in thermal communication with an external heat source, while the condensing section is disposed in thermal communication with an external heat sink. Further, an adiabatic section connects the evaporating section to the condensing section, with heat being transmitted within the heat pipe from the evaporating section to the condensing section via the adiabatic section.

In order to ensure the effective operation of the heat pipe, the liquid working fluid should have good heat conductive performance, so that the heat from the evaporating section can be transmitted to the condensing section rapidly. A conventional working fluid is composed of a liquid solvent, a plurality of nano-particles dispersed in the liquid solvent, and a surface-active agent for preventing the nano-particles from aggregating in the liquid solvent. The liquid solvent can be pure alcohol, Freon, water or acetone. However, the surface-active agent may cause a lot of foams, which may prevent the working fluid from flowing between the evaporating section of and the condensing section. This result will greatly lower the thermal conductivity of the heat pipe.

It is therefore desirable to provide a working fluid that overcomes the above-described problems.

### SUMMARY OF INVENTION

A working fluid for a heat pipe includes a liquid solvent, a plurality of nano-particles dispersed in the liquid solvent, and a polymer stability agent configured for preventing the nano-particles from aggregating in the liquid solvent.

A method for manufacturing a heat pipe working fluid includes the steps of: (a) providing a vessel containing a liquid solvent containing a polymer stability agent dispersed therein, the polymer stability agent being configured for preventing the created nano-particles from aggregating in the liquid solvent; (b) arranging a target in the liquid solvent; and (c) bombarding the target to create nano-particles, whereupon the nano-particles are dispersed into the polar solvent, thereby obtaining the working fluid.

Advantages and novel features will become more apparent from the following detailed description when taken in conjunction with the accompanying drawings.

### BRIEF DESCRIPTION OF DRAWINGS

Many aspects of the present working fluid and method of manufacturing the same can be better understood with reference to the following drawings. The components in the drawings are not necessarily drawn to scale, the emphasis instead being placed upon clearly illustrating the principles of the present working fluid and method of manufacturing the same. Moreover, in the drawings, like reference numerals designate corresponding parts throughout the several views.

FIG. 1 is a schematic, cross-sectional view of a vessel containing a working fluid in accordance with a first embodiment;

FIG. 2 is a schematic, cross-sectional view of an apparatus for manufacturing the working fluid of FIG. 1 in accordance with a second embodiment; and

FIG. 3 is a cross-sectional view of an apparatus for manufacturing the working fluid of FIG. 1 in accordance with a third embodiment.

### DETAILED DESCRIPTION

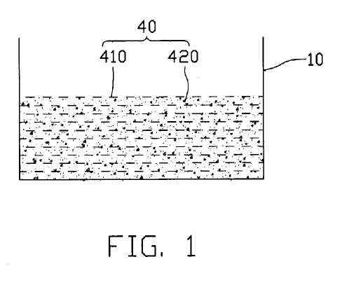

Referring to FIG. 1, there is shown a vessel 10 containing a working fluid 40 in accordance with a first embodiment. The working fluid 40 includes a liquid solvent containing a plurality of nano-particles 420 dispersed therein, and a polymer stability agent 410 is configured for preventing the nano-particles 420 from aggregating in the liquid solvent. The liquid solvent itself can be made of a substance suitable as a working fluid for a heat pipe, while, it can dissolve the polymer stability agent 410. The polymer stability agent 410 has a spatial chain configuration in structure, which can obstruct the nano-particles 420 from aggregating. In molecular structure, the polymer stability agent 410 can be a polar molecule or a non-polar molecule, so the corresponding liquid solvent can also be a polar solvent or a non-polar solvent. As a polar molecule, the polymer stability agent 410 can be poly vinyl alcohol (PVA) or poly vinyl pyrrolidone (PVP), then the corresponding liquid solvent can be a polar solvent, such as a polar solvent containing a hydroxyl group. The polar solvent containing a hydroxyl group may be water or alcohol. The nano-particles can be comprised of a material selected from the group consisting of carbon, metal, and a combination thereof. Advantageously, the metal is selected from the group consisting of silver (Ag), gold (Au), copper (Cu) or an alloy of these metals.

The inclusion of a polymer stability agent 410 in the present working fluid 40 prevents the nano-particles 420 from aggregating, thus giving it great advantages over conventional working fluids. Thus, in the working fluid 40, the high heat conducting nano-particles 420 are uniformly dispersed in the liquid solvent, which gives the working fluid 40 an excellent thermal conductivity performance.

A method for manufacturing the working fluid 40 includes the steps of: providing a liquid solution with a liquid solvent and a polymer stability agent dispersed therein; and introducing a plurality of nano-particles into the liquid solution to obtain the working fluid 40. Preferably, the nano-particles disperse in the stability agent uniformly, thus the obtained working fluid 40 will display a uniform thermal conductivity performance. The nano-particles are dispersed uniformly into the stability agent by methods such as blending, ultrasonic vibrating and so on.

In the above method, the provided liquid solvent itself can be made of a substance suitable as a working fluid for a heat pipe. In the liquid solution, the polymer stability agent has a spatial chain configuration in structure, which can obstruct the nano-particles from aggregating. In structure, the polymer stability agent can be a polar molecule or a non-polar molecule, so the corresponding liquid solvent can also be a polar solvent or a non-polar solvent. As a polar molecular, the polymer stability agent can be poly vinyl alcohol or poly vinyl pyrrolidone, then the corresponding liquid solvent can be a polar solvent containing a hydroxyl group. The nano-particles may be comprised of a material selected from the group consisting of carbon, metal, and a combination thereof. Advantageously, the metal is selected from the group consisting of Ag, Au, Cu or an alloy of these metals.

In illustrated embodiment, the method for manufacturing the working fluid 40 involves a laser ablation process. The working fluid 40 is mainly consisted of poly vinyl alcohol aqueous solution and nano-scaled copper particles dispersed therein. The laser ablation process includes the steps of: providing a vessel containing a liquid solution including water and poly vinyl alcohol; setting a target in the liquid solution; bombarding the target to create nano-particles, whereupon the nano-particles are dispersed into the liquid solution, thereby obtaining a working fluid. Such working fluid can be used in heat pipes, and other cooling systems.

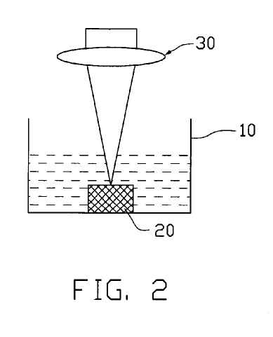

FIG. 2 shows an apparatus for manufacturing a working fluid 40 in accordance with a second embodiment. The apparatus includes a vessel 10 for holding a poly vinyl alcohol aqueous solution, a copper target 20 and a laser device 30. The copper target 20 is immersed in the poly vinyl alcohol aqueous solution, preferably, wholly immersed in the poly vinyl alcohol aqueous solution. The laser device 30 is used to bombard the copper target 20 to produce nano-scaled copper particles, so it can be located an appropriate distance away from the copper target 20. With such apparatus, the desired working fluid 40 can be manufactured via the following steps. Firstly, adjusting the laser device 30 to aim at the copper target 20, then bombarding the copper target 20 with a laser beam generated by the laser device 30 to produce nano-scaled copper particles. The produced particles then disperse into the poly vinyl alcohol aqueous solution, thus obtaining the desired working fluid 40 which include the poly vinyl alcohol aqueous solution and a plurality of nano-scaled copper particles dispersed therein.

Because nano-scaled copper particles easily agglomerate, so a vibrating process is preferably performed to disperse the nano-scaled copper particles uniformly into the poly vinyl alcohol aqueous solution. The poly vinyl alcohol has a spatial chain configuration in structure, which can obstruct the nano-scaled copper particles from aggregating and cause the nano-scaled copper particles to disperse uniformly in the poly vinyl alcohol aqueous solution. Therefore, the working fluid 40 with the nano-scaled copper particles uniformly dispersed therein exhibits excellent and uniform heat conducting characteristics.

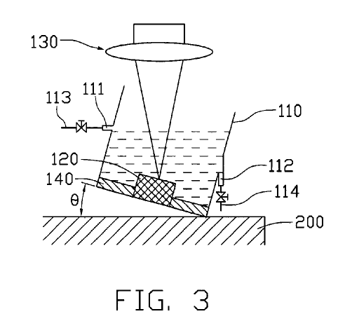

FIG. 3 shows an apparatus 100 for continuously manufacturing the working fluid 40 in accordance with a third embodiment. The apparatus 100 includes a vessel 110 containing the poly vinyl alcohol aqueous solution, a copper target 120, a laser device 130 and an ultrasonic device 140. The vessel 110 is arranged on a base 200, and the vessel 110 and the base 200 form an appropriate angle. The angle is in a range from above about zero degrees to about 60 degrees. The vessel 110 defines an inlet 111 and an outlet 112. The inlet 111 is connected with an input tube 113 with a valve configured thereon. The outlet 112 is connected with an output tube 114 with a valve configured thereon. The copper target 120 is arranged inside the vessel 110 and embedded with the poly vinyl alcohol aqueous solution. The laser device 130 is located an appropriate distance away from the copper target 120.

With the apparatus 100, the working fluid 40 can be continuously manufactured by the following steps. Firstly, an appropriate volume of the poly vinyl alcohol aqueous solution can be supplied via the input tube 113, while the valve of the output tube 114 is closed. In this first step, perfectly, the poly vinyl alcohol aqueous solution can embed in the copper target 120. Secondly, adjusting the laser device 130 to aim at the copper target 120, then bombarding the copper target 120 to gain nano-scaled copper particles, whereupon the nano-scaled copper particles are dispersed into the poly vinyl alcohol aqueous solution, thus, obtaining a desired working fluid 40 which include the poly vinyl alcohol aqueous solution and a plurality of nano-scaled copper particles dispersed therein. Preferably, in this step, the ultrasonic device 140 should continuously vibrate the poly vinyl alcohol aqueous solution to prevent the nano-scaled copper particles from congregating, thus making the nano-scaled copper particles disperse uniformly in the poly vinyl alcohol aqueous solution. Thirdly, once the desired concentration of the nano-scaled copper particles in the working fluid 40 is reached, opening the valve of the output tube 114 to collect the working fluid 40. Adjusting an input flow-rate of the poly vinyl alcohol aqueous solution, an output flow-rate of the desired working fluid 40, and bombarding frequency of the laser device 140 to keep a stable concentration of the desired working fluid 40 in the vessel 110.

The inclusion of a polymer stability agent 410 in the present working fluid 40 prevents the nano-particles 420 from aggregating, thus, in the working fluid 40, the high heat conducting nano-particles 420 are uniformly dispersed in the liquid solvent, which gives the working fluid 40 an excellent thermal conductivity performance. In the present method, the above-described working fluid is manufactured simultaneously with the creation of the nano-scaled particles by the laser ablation method. In addition, the liquid solvent for dispersing the nano-particles contains a polymer stability agent which prevents the created nano-particles 420 from aggregating, therefore, without adding other agents for example a surface-active agent, the created nano-scaled particles can also be uniformly dispersed in the liquid solvent.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A working fluid for a heat pipe comprising:
a liquid solvent;
a plurality of nano-particles dispersed in the liquid solvent; and
a polymer stability agent configured for preventing the nano-particles from aggregating in the liquid solvent.

2. The working fluid for a heat pipe as claimed in claim 1, wherein the polymer stability agent is one of poly vinyl alcohol and poly vinyl pyrrolidone.

3. The working fluid for a heat pipe as claimed in claim 2, wherein the liquid solvent is a polar solvent containing a hydroxyl group.

4. The working fluid for a heat pipe as claimed in claim 3, wherein the polar solvent is water.

5. The working fluid for a heat pipe as claimed in claim 1, wherein the nano-particles are comprised of a material selected from the group consisting of carbon, metal and a mixture thereof.

6. The working fluid for a heat pipe as claimed in claim 1, wherein a shape of the nano-particle is selected from the group consisting of nano-tubes, nano-spheres, nano-rods, nano-lines, hollow capsules and any mixture thereof.

7. A method for manufacturing a working fluid for a heat pipe, comprising the steps of:
providing a vessel containing a liquid solvent containing a polymer stability agent dispersed therein, the polymer stability agent being configured for preventing the created nano-particles from aggregating in the liquid solvent;
arranging a target in the liquid solvent; and
bombarding the target to create nano-particles, whereupon the nano-particles are dispersed into the polar solvent, thereby obtaining the working fluid.

8. The method as claimed in claim 7, wherein the polymer stability agent is one of poly vinyl alcohol and poly vinyl pyrrolidone.

9. The method as claimed in claim 8, wherein the liquid solvent is a polar solvent containing a hydroxyl group.

10. The method as claimed in claim 9, wherein the polar solvent is water.

11. The method as claimed in claim 7, wherein a material of the target is selected from the group consisting of carbon, metal and a mixture thereof.

12. The method as claimed in claim 7, wherein the target is completely immersed into the liquid solvent.

13. The method as claimed in claim 7, wherein during performing the step of bombarding the target, the liquid solvent containing the polymer stability agent is vibrated.
